(19) United States
(12) Patent Application Publication
(10) Pub. No.: US 2012/0278196 A1
(43) Pub. Date: Nov. 1, 2012

(54) System And Method For Evaluation of Literary Submissions

(76) Inventor: Nayia Moysidis, Miami, FL (US)

(21) Appl. No.: 13/095,007

(22) Filed: Apr. 27, 2011

(51) Int. Cl. G06Q 30/00

(52) U.S. Cl. 705/26.3

(57) ABSTRACT

A system and method are provided for evaluation of literary submissions involving writers, readers, and editors/publishers. The method includes receiving registration data from writers, readers, and editors/publishers, and receiving a plurality of submissions of literary works produced by the writers. The readers are provided access to the submissions; votes are received from the readers regarding the submissions in a first round of voting. Finalist submissions and finalist writers are determined in accordance with the voting by the readers. The editors/publishers are provided access to the submissions, and auction bids are received from the editors/publishers in an auction with regard to the finalist submissions. At the conclusion of the auction, the winning editor/publisher for each of the finalist submissions is determined, so that each of the finalist submissions is published first as an E-book and at a later point, if desired, in paperback or hardcover.

### FIELD OF THE DISCLOSURE

This disclosure relates to publishing works by previously unpublished writers, and more specifically to a system facilitating interaction between writers, readers, editors, and publishers in order to provide opportunity for new writers.

### BACKGROUND OF THE DISCLOSURE

New writers face substantial obstacles when attempting to publish a first manuscript, usually because they are unknown in the literary world. Many editors and publishing houses receive a very large number of unsolicited manuscripts, many of which are neglected due to lack of editors' time or the manuscript's inferior quality. Editors are aware, however, that in every pile of disregarded submissions some have the potential to become bestsellers, gaining acclaim for the writer and publishing house alike.

New writers typically have a very limited audience for their work. After sending an entire completed novel to literary agencies and receiving either rejections or no responses whatsoever, many new writers attempt to send their manuscripts to editors directly, without knowing whether their submissions will ever be evaluated by an editor, let alone widely read. Readers, particularly those interested in a specific genre, often wish they could offer input to writers and contribute to the writers' creative process.

It therefore is desirable to implement a system where writers, readers and publishers may interact for mutual benefit, with the objective of giving new writers greater opportunity to be published and recognized, readers the opportunity to demonstrate their literary prowess, and editors/publishers the opportunity to find the masterpieces in a pile of otherwise disregarded submissions.

### SUMMARY OF THE DISCLOSURE

The present disclosure provides a method for evaluation of literary submissions involving writers, readers, and publishers, for execution on a computing device (and advantageously using a web site hosted on that device). The method includes receiving registration data from writers, readers, editors, and publishers, and receiving a plurality of submissions of literary works produced by the writers. The readers are provided access to the submissions; votes are received from the readers regarding the submissions in a first round of voting. A group of finalist submissions (and a corresponding group of finalist writers) are determined in accordance with the voting by the readers. The editors/publishers are provided with access to the submissions, and auction bids are received from the editors/publishers in an auction with regard to one or more of the finalist submissions. At the conclusion of the auction, the winning editor/publisher for each of the finalist submissions is determined, and the finalist writer and editor/publisher are notified accordingly.

In an embodiment, additional votes are received from the readers in a second round of voting, and a rank order of the finalist submissions is determined in accordance with those second-round votes. Additional submissions may be received from the writers prior to the second round of voting. Further submissions may be received from the writers prior to the auction, so that the publishers have access to a complete work by each finalist writer prior to the auction.

In another embodiment, an advance bid may be received from each of the publishers, prior to the auction. The publisher with the highest advance bid may be awarded an exclusive right to publish the highest-ranked submission; the auction then includes receiving bids from the remaining publishers with respect to the remaining submissions.

In accordance with another aspect of the disclosure, a system includes a server hosting a web site on which the above-described method is performed. Each of the writers, readers, and editors/publishers may have their own page on the web site. In an embodiment, the web site may serve as a social network for professionals and others interested in the literary world.

In accordance with a further aspect of the disclosure, a computer-readable storage medium has stored thereon instructions for performing the above-described method.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic illustration of a web site accessed by writers, readers and editors/publishers to evaluate literary submissions, in accordance with an embodiment of the disclosure.

FIG. 2 is a flowchart showing a simplified process wherein a submission from a new writer is received at a web site embodying the disclosure, and is evaluated by readers and editors/publishers having access to the web site.

FIG. 3 is a flowchart showing details of the process of FIG. 2, in which several writers' submissions are voted on by readers to determine a select group of finalists.

FIG. 4 is a flowchart showing additional details of the process of FIG. 2, in which the manuscripts of the finalist writers identified in the process of FIG. 3 are the subjects of a silent auction with the editors/publishers as bidders.

FIG. 5 schematically illustrates a system, including a computing device, according to an embodiment of the disclosure.

### DETAILED DESCRIPTION

In accordance with an embodiment of the disclosure, participants in a literary evaluation process (writers, readers and editors/publishers) have access to a web site for receiving submissions from writers, and votes and comments from readers; for holding a contest among the writers with readers as voters; and for providing a platform for an auction in which publishers bid on the right to publish a manuscript. This process, and the web site supporting the process, are referred to herein as “Writer's Block.”

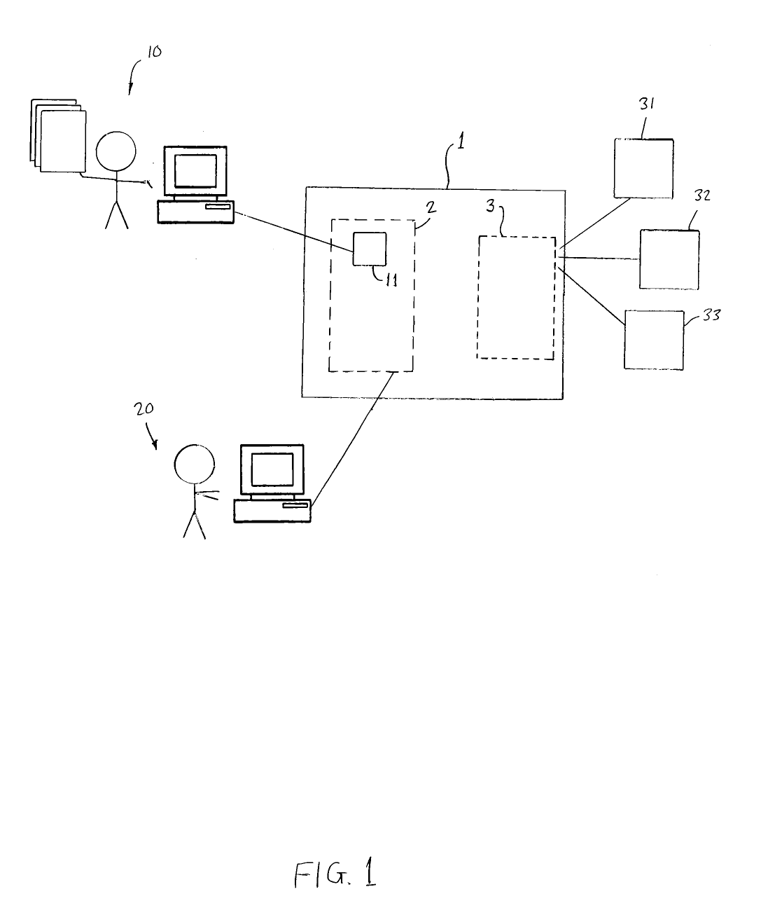

FIG. 1 schematically illustrates a web site 1 having a submission evaluation function 2 (involving the writers and readers) and an auction function 3 (involving the editors/publishers). The writer 10 submits a work 11 (or a portion thereof) to be posted on the web site, which is accessed by reader 20. After one or more rounds of voting by readers (described in detail below) to determine the highest-rated submissions, editors/publishers 31-33 enter in a silent auction in which they bid for those submissions. The term “editor,” as used herein, generally refers to a person associated with a publishing house. During the auction phase of the Writer's Block process, the editor makes a bid in the name of his/her publishing house. In an embodiment, each participant has a page maintained on the site, with features depending on the type of participation:

Writers have a page having a layout listing their submissions; these pages are public. A writer also has the option to create a blog.

Readers have a page having a layout listing their voting history, and on which they may state their literary preferences (e.g. which genre they wish to vote on). A reader may also list his/her favorite submission for each contest, and build a list of submissions in rank order over the course of a contest. These pages may be private or public.

Editors and publishers have a page with a layout different from writers and readers. These pages are private, and are used to submit auction bids.

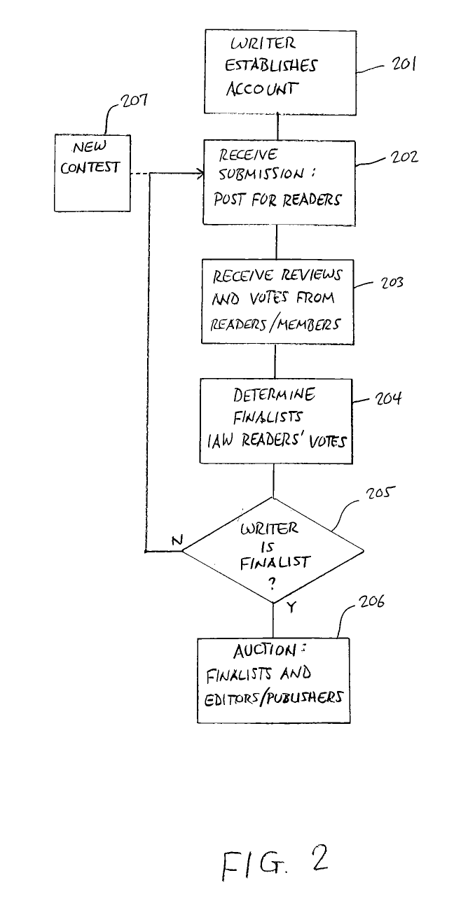

The Writer's Block process may be viewed as a contest with distinct phases: a submission phase, a voting phase, and a silent auction phase. A flowchart with features of the process is shown in FIG. 2. In order to become a member on the Writer's Block site according to this embodiment, a writer who registers for a writer's account must be previously unpublished; that is, submission 11 must be fresh material to the general public. In the example described below, the writer's submission is assumed to be a novel; writers who have previously published short stories or poems would be permitted to submit novels. Writers who have previously submitted novels may register as readers.

A writer meeting these criteria establishes an account on the Writer's Block site (step 201) and provides pertinent information, e.g. name, pen name, e-mail address and mailing address. New writers are also asked how they were referred to Writer's Block. If a publishing house referred them, they are asked to identify the house (e.g. by selecting from a drop down menu). In this embodiment, a publishing house must refer at least two writers, who are then contacted by Writer's Block for confirmation, before their accounts as publisher participants are approved for use.

The web site then receives submission 11 from writer 10 (step 202). A writer may post up to a specified number of pages of a new (unsolicited and previously unseen) novel. Writer's Block does not perform any editing or formatting of the submission; this is the responsibility of the writer. In step 203, the web site receives input from readers who have registered as members of the site. A reader may post comments regarding a submission, may make blog entries regarding his own literary preferences, and may submit votes on the various submissions.

The web site tabulates the readers' votes and determines which writers are finalists (step 204). If a writer is a finalist (step 206), his work will be bid on in the auction phase of the contest. As detailed below, there may be one or more additional rounds of voting to rank the finalists and thus determine an overall winner of the voting phase. If the writer is not a finalist, he may submit the work in the submission phase of a new contest 207.

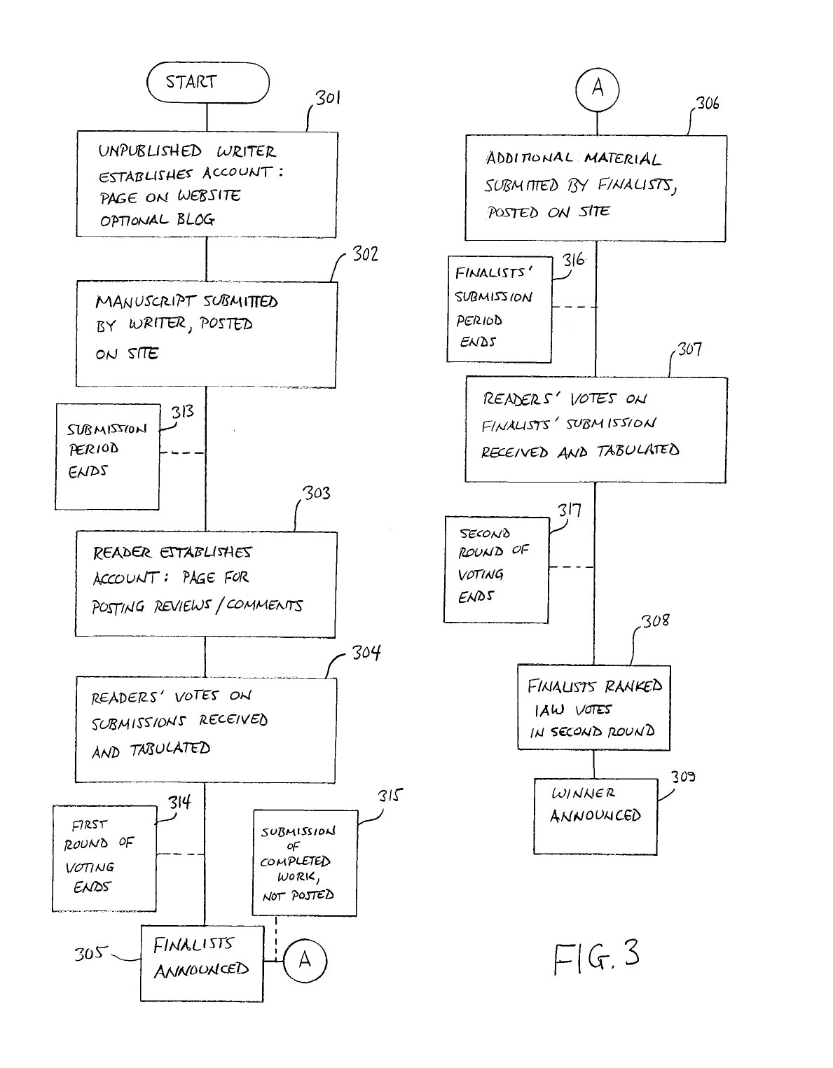

FIG. 3 shows a flowchart with additional details of the Writer's Block process, in accordance with an embodiment of the disclosure. In the submission phase of the contest, an unpublished writer 10 establishes an account on the web site (step 301), and is provided with a public page. The writer has the option to post short statements on the page, to inform readers of current work in progress (for example, updating the status of further submissions during the current contest), literary news of interest to the writer, etc. The writer also has the option to create a blog in order to interact with readers and conduct his own public relations or advertising. The web site receives and posts a manuscript submitted by the writer (step 302), typically a portion of a novel (the portion having a convenient maximum length such as 20 pages). Submissions are accepted at the web site for only a preannounced period of time. The voting phase begins at the end of the submission period 313.

Persons other than writers may register with the web site as readers (step 303). A reader may establish an account and become a member of Writer's Block before or during the submission period, but will not have access to the submissions until the submission period ends.

During the voting phase of the contest, a reader may submit a vote on any of the submissions to the web site. In this embodiment, the reader awards a rating of “1” to “10” to the writer's work. The reader may also create a blog to record his comments regarding the work he has read. Readers thus may post their opinions of various writers, and interact with one another, as they would in a reading group.

In an embodiment, some readers may be recognized over time as having more valued opinions than others. Initially, each member's votes will count equally. However, at the completion of each contest, members who participated in more votes (that is, undertook to evaluate a greater number of works) may earn an extra percentage on their votes for a subsequent contest. A reader may gain different levels of acclaim, which may be displayed on the reader's account, e.g. with 1 to 5 golden stars. A reader who has 2 golden stars thus may have a vote that counts as 110% of that of a beginning (1 star) reader. This assists in avoiding the phenomenon of a writer's friends and family who register as members and then only vote for one submission.

The web site receives and tabulates all of the reader's votes (step 304). In this embodiment, the web site monitors each reader's voting activity to ensure that a reader votes on each submission only once. Voting continues for a preannounced period of time. At the end of the voting 314, the writers with the highest number of readers' votes are announced as finalists (step 305). In this embodiment, there is no limit to the number of writers who may submit manuscripts (portions of novels), but only a set number of finalists (e.g. 10) are announced.

Each finalist is then required to submit his entire work (that is, a completed manuscript) to the Writer's Block site. These completed manuscripts are not posted on the site and not released to the public, but are made available later to the publishers participating in the auction phase. A writer failing to submit the completed work loses his finalist status and is replaced by the writer with the next-highest number of votes. The finalists' novels (per agreement made when the writer first registers at the Writer's Block site) may not be removed from the Writer's Block site to be submitted elsewhere.

The finalists are then required to submit additional material for posting on the web site, in advance of an additional round of voting (step 306). This additional material is another portion of the writer's novel, with a maximum number of pages such as 50 pages. After these additional submissions have been received (316), the readers again vote to determine a ranking of the finalists (step 307). This second round of voting continues for a preannounced period of time; at the end of this round 317, the rankings of the finalists are determined (step 308), and an overall winner is announced (step 309).

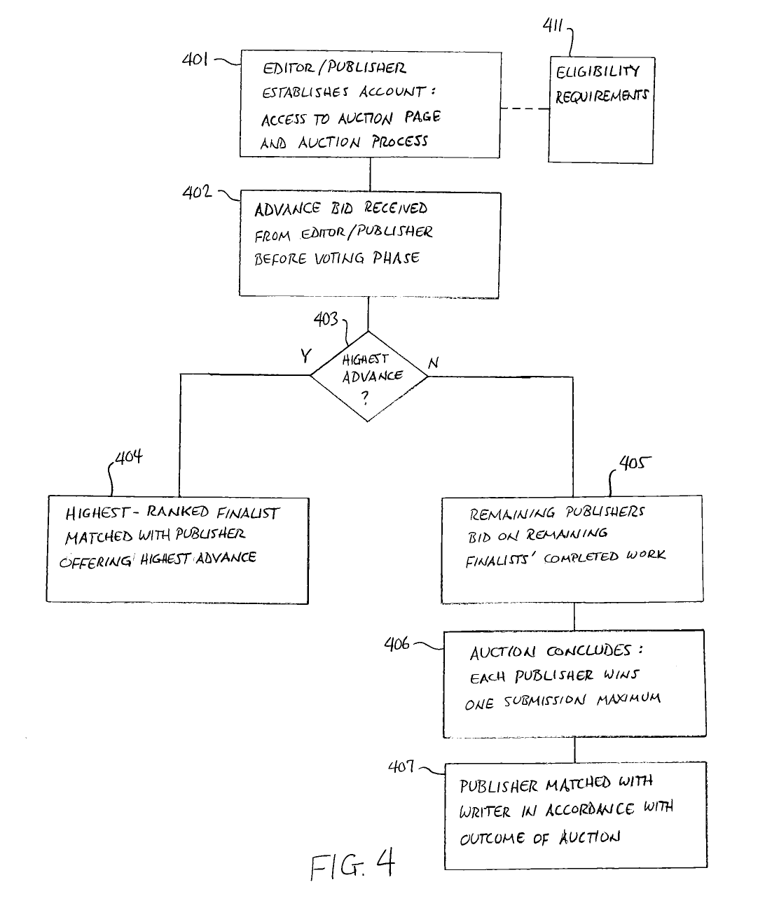

The auction phase of the contest is shown in the flowchart of FIG. 4. An editor/publisher establishes an account at the Writer's Block web site that permits access to the auction process (step 401). Each participating editor/publisher must meet eligibility requirements 411; in this embodiment, a publishing house must have referred a specified number of writers to Writer's Block who are registered members of the site. An editor/publisher's account is activated only after those writers confirm that they were referred by that publisher. An editor/publisher's account is private to other members. An editor/publisher may not use his account to vote on submissions during the voting phase, but may register as a reader and submit votes using the reader account.

The participating editors/publishers have the opportunity to submit advance bids (step 402) for exclusive rights to the manuscript of the winning writer (the writer ranked #1 at the end of the voting phase). In this embodiment, advance bids are received at the Writer's Block site before the voting phase. Alternatively, publishers may submit advance bids during the first submission process, before any voting has occurred.

The publisher offering the highest advance (403) is matched with the writer who is the overall winner of the voting (step 404). The remaining publishers may then bid on the remaining finalists' works (step 405); the highest bidder for each work wins the right to publish that work (step 406). In this embodiment, a given publisher is restricted to winning rights to only one submission. A participating publisher may bid on as many submissions as desired, but their high bid will be honored for only one submission; this restriction helps to ensure that all publishers have an equal opportunity to win rights to a manuscript. Writer's Block then notifies each publisher (winning bidder for a given submission) and the writer of that submission (step 407).

The finalist writers, and the publishers who have won the rights to their works at the conclusion of the auction phase, then enter into contracts to have the works published. The works obtained by the publishers will be published initially as E-books, with minimal production costs. A publisher may later decide to publish the work in paperback or hardcover. In an embodiment, the finalist submissions may be required to be published as E-books for a specified period of time before they may be produced in paperback or hardcover.

In order to attract more writers and publishers to the Writer's Block web site, publishers wishing to participate may be required to confirm by contract that they will create an account and direct all writers with unsolicited manuscripts to Writer's Block. In this embodiment, there is no cost for membership on the Writer's Block site.

Multiple Writer's Block processes may be in progress at any given time. Accordingly, one or another group of submissions may be available for reading on a continuous basis. A reader member of Writer's Block will thus be encouraged to visit the site often. A writer who has not been chosen as a finalist in one edition of the Writer's Block process may make the same submission in a later edition of the process. An editor/publisher member of Writer's Block may participate in multiple auctions at the same time, involving different sets of finalists from different editions of the process.

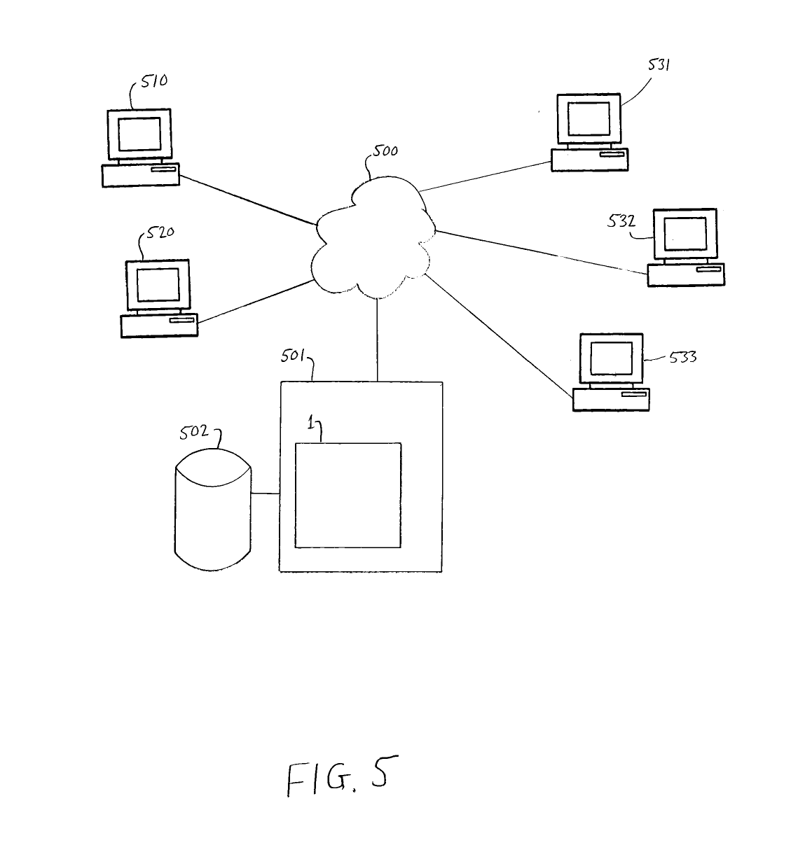

A system configured to execute the Writer's Block process, in accordance with an embodiment of the disclosure, is shown schematically in FIG. 5. The Writer's Block web site 1 is hosted on one or more servers 501 connected to network 500, such as the Internet. Writer 10 and reader 20 use computing devices 510 and 520 to communicate with the server, and make submissions to the web site, via network 500. Editors/publishers 31, 32, 33 similarly use computing devices 531, 532, 533 to submit bids via network 500 in the auction phase of the process. Data submitted to the web site (manuscripts, comments, votes, bids, etc.) may be maintained on a storage device 502.

Although FIG. 5 shows the writers, readers, and publishers communicating with the server using personal computers, it will be appreciated that the computing devices may be any of a wide variety of devices capable of accessing a web site via the Internet (e.g. an iPhone, electronic reader, PDA, etc.).

The Writer's Block web site 1 may be thought of as a forum where a work 11 is critiqued and evaluated, and as an auction venue for the work. More generally, the web site 1 may serve as a social network for anyone and everyone interested in the literary world and professionals of the literary world.

It will be appreciated that Writer's Block offers advantages for writers, readers, and publishers. New writers have an opportunity to overcome the obstacle of obtaining an agent or publishing a first manuscript. The site provides a professional context through which readers can interact with the writers, eliminating the void between a new writer and the reader and helping to create better literary works. In other embodiments, web sites with features similar to Writer's Block may eliminate the void between the audience and the artist in various other forms of art, creating a final product through cooperation and encouragement.

The Writer's Block process shows the importance of the reader in the literary world, by involving both the reader and writer. Writers clearly benefit by having an audience provided before a new novel is even published. Readers who have voted for a submission and followed its development will already be invested in the success of the new novel. Readers who vote more often can gain acclaim as voters, and therefore, their votes will count more than sporadic voters. Writer's Block also provides an electronic venue through which readers can interact with one another and find their favorite new writers, thus functioning as a virtual book club. It offers free reading material for E-books and grants readers opportunities to participate in a perpetual online workshop in which everyone is a literary reviewer.

Writer's Block gives editors and publishers a tool for sorting through piles of unsolicited manuscripts, many of which are discarded in their entirety, and find the pieces that possess potential. The Writer's Block process also shows the importance of the publishing house in the literary world, despite the technological advances in electronic books. Furthermore, it provides a method by which publishing houses can interact with one another, through the silent auction process, to bid on their favorite new novel.

Finally, Writer's Block helps to redefine the financial organizational structure of the publishing world. Since the novels will first be published as E-books, the cost of the publishing house will be minimal. Writer's Block shows that neither self-publication nor the avoidance of electronic publishing benefit the literary world.

Through the revision of the financial structure and the methods through which publication occurs, Writer's Block aims to utilize technology in order to find the most efficient, beneficial, and exciting methods for publishing new writers.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A method, for execution on a computing device, comprising:
receiving registration data from writers, readers, and publishers;
receiving a plurality of submissions of literary works, said literary works produced by the writers;
providing the readers with access to the submissions;
receiving votes from the readers regarding the submissions in a first round of voting;
determining a group of finalist submissions and a corresponding group of finalist writers in accordance with said votes;
providing the publishers with access to the submissions;
receiving auction bids from the publishers in an auction with regard to one or more of said finalist submissions;
determining the outcome of the auction, including the winning publisher for each of said finalist submissions; and
notifying the finalist writer and the winning publisher for each of the respective finalist submissions.

2. A method according to claim 1, further comprising, subsequent to said step of determining a group of finalist submissions:
receiving additional votes from the readers regarding the submissions in a second round of voting; and
determining a rank order of the finalist submissions in accordance with said additional votes.

3. A method according to claim 2, further comprising receiving additional submissions from the writers prior to the second round of voting.

4. A method according to claim 1, further comprising receiving additional submissions from the writers prior to said step of receiving auction bids, so that the publishers have access to a complete work by each finalist writer prior to the auction.

5. A method according to claim 2, wherein said step of receiving auction bids further comprises receiving an advance bid from each of the publishers,
and further comprising:
awarding the publisher with the highest advance bid an exclusive right to publish the highest-ranked submission,
so that said auction includes receiving bids from the remaining publishers with respect to the remaining finalist submissions.

6. A method according to claim 2, wherein a vote received from a first reader is accorded greater value than a vote received from a second reader, in accordance with participation in previous rounds of voting by said first reader and second reader respectively.

7. A method according to claim 1, wherein said method is performed using a web site having a plurality of pages, and further comprising:
establishing a web page on the web site associated with each of the writers, readers and publishers in accordance with said registration data, a page associated with a publisher being accessed and maintained by an editor associated with that publisher.

8. A method according to claim 7, further comprising causing a submission from a writer to be posted on the page associated with that writer, thereby enabling the readers to read the submission.

9. A method according to claim 7, wherein a page associated with at least one writer includes at least one of a blog and a status update maintained by that writer.

10. A method according to claim 7, further comprising establishing eligibility criteria for registration by publishers.

11. A method according to claim 10, wherein said eligibility criteria include prior referral by the publisher of a specified number of writers registered at the web site.

12. A method according to claim 5, further comprising the step of causing each of the finalist submissions to be published as an E-book, and wherein each of the finalist submissions is published only as an E-book for a specified period of time.

13. A system comprising:
a server configured to
receive registration data from writers, readers, and editors/publishers;
receive a plurality of submissions of literary works, said literary works produced by the writers;
provide the readers with access to the submissions;
receive votes from the readers regarding the submissions in a first round of voting;
determine a group of finalist submissions and a corresponding group of finalist writers in accordance with said votes;
provide the editors/publishers with access to the submissions;
receive auction bids from the publishers in an auction with regard to one or more of said finalist submissions;
determine the outcome of the auction, including the winning publisher for each of said finalist submissions; and
notify the finalist writer and the winning publisher for each of the respective finalist submissions.

14. A system according to claim 13, wherein said server is further configured to
receive additional votes from the readers regarding the submissions in a second round of voting; and
determine a rank order of the finalist submissions in accordance with said additional votes.

15. A system according to claim 14, wherein said server is further configured to receive additional submissions from the writers prior to the second round of voting.

16. A system according to claim 13, wherein said server is further configured to receive additional submissions from the writers prior to receiving the auction bids, so that the publishers have access to a complete work by each finalist writer prior to the auction.

17. A system according to claim 13, wherein said server is configured to host a web site and to communicate with the writers, readers and publishers over the Internet.

18. A system according to claim 17, wherein said server is configured so that the web site has a social network function for persons interested in the literary world.

19. A computer-readable storage medium having stored thereon instructions for performing a method, the method comprising the steps of
receiving registration data from writers, readers, and editors/publishers;
receiving a plurality of submissions of literary works, said literary works produced by the writers;
providing the readers with access to the submissions;
receiving votes from the readers regarding the submissions in a first round of voting;
determining a group of finalist submissions and a corresponding group of finalist writers in accordance with said votes;
providing the editors/publishers with access to the submissions;
receiving auction bids from the editors/publishers in an auction with regard to one or more of said finalist submissions;
determining the outcome of the auction, including the winning editor/publisher for each of said finalist submissions; and
notifying the finalist writer and the winning publisher for each of the respective finalist submissions.

20. A computer-readable storage medium according to claim 19, wherein the method further comprises:
subsequent to said step of determining a group of finalist submissions,
receiving additional submissions from the writers,
receiving additional votes from the readers regarding the submissions and additional submissions in a second round of voting, and
determining a rank order of the finalist submissions in accordance with said additional votes; and
receiving further additional submissions from the writers prior to said step of receiving auction bids, so that the editors/publishers have access to a complete work by each finalist writer prior to the auction.
